(19) United States
(12) Patent Application Publication
(10) Pub. No.: US 2024/0388455 A1
(43) Pub. Date: Nov. 21, 2024

(54) DATA MANAGEMENT SYSTEM AND DATA MANAGEMENT METHOD

(71) Applicant: Hitachi, Ltd., Tokyo (JP)

(72) Inventor: Koshi IKEGAWA, Tokyo (JP)

(73) Assignee: Hitachi, Ltd., Tokyo (JP)

(21) Appl. No.: 18/690,108

(22) PCT Filed: Jan. 27, 2023
(86) PCT No.: PCT/JP2023/002675

§ 371 Date: Mar. 7, 2024

(30) Foreign Application Priority Data
May 16, 2022 (JP) 2022-080362

(51) Int. Cl. H04L 9/00

(52) U.S. Cl. CPC H04L 9/50

(57) ABSTRACT

In a data management system 0001 configured to manage data usage between organizations participating in a distributed ledger system, in a node of a first organization, data is encrypted and passed to a node of a second organization, and in an encrypted region in the node of the second organization, the encrypted data is decrypted and predetermined processing is executed on the decrypted data.

### TECHNICAL FIELD

The present invention relates to a data management system and a data management method.

### BACKGROUND ART

To implement DFFT (Data Free Flow with Trust) proposed in 2019, a system is needed for a plurality of organizations such as countries and corporations to share and use data. One means of implementing such a system is distributed ledger technology, which allows a plurality of organizations to operate a system with the same authority.

Distributed ledger technology is a technique whereby transactions heretofore made via a central authority (for example, a trustworthy organization such as a financial institution or a government) are replaced by transactions carried out directly between users using P2P (peer to peer) communications.

Various derivative techniques have been proposed for such distributed ledger technology, and therefore distributed ledger technology is continuously evolving. Its main characteristics at present include (1) a transaction between participants in a distributed ledger is finalized not by a central authority but through consensus building and approval by (any or particular) participants, (2) a plurality of transactions are grouped together as a block, blocks are recorded like a chain in a distributed ledger called a blockchain, and hashes are calculated for consecutive blocks to make falsification impossible, and (3) all participants share the same ledger data so that the transactions can be checked by all the participants.

Due to the characteristics described above, such distributed ledger technologies using blockchains are being considered for various fields such as the financial and manufacturing industries as a reliable system for managing/sharing data and conducting/managing transactions based on contracts.

At the same time, because distributed ledger technology is characterized in that data is shared by all the participating organizations, in order to comply with laws such as the EU General Data Protection Regulation, handling of sensitive data that requires privacy protection comes with difficulty.

Thus, for example, a technique providing a method, an apparatus, a device, and a storage medium for blockchain privacy data processing (see PTL 1) has been proposed as a conventional technique related to privacy protection in blockchains.

This technique is a blockchain privacy data processing method executed at a blockchain node, the method including a step of obtaining a data calculation transaction request initiated by a data user based on a privacy smart contract, the data to be called by the data calculation transaction request being data subjected to blinding processing by the data user; a step of obtaining homomorphically encrypted source data with the data calculation transaction request; a step of using a calculation task in the data calculation transaction request to call the privacy smart contract, executing calculation on the data called and the source data, and obtaining calculation results; and a step of uplinking the data calculation transaction request and the calculation results and giving feedback to the data user with the data calculation transaction request, so that the data user performs homomorphic decryption and un-blinding processing on the calculation results to obtain calculation results in plain text.

### CITATION LIST

### Patent Literature

[PTL 1] Japanese Patent Application Publication No. 2021-26236

### Non Patent Literature

[NPL 1] Hyperledger Avalon

[NPL 2] Hyperledger Fabric Private Chaincode

### SUMMARY OF THE INVENTION

### Technical Problem

In handling of sensitive data, encryption is necessary regardless of whether it is saved in a blockchain or saved locally. When sensitive data is to be shared between users in such an environment, handling of a decryption key is a challenge. For example, if the key is simply passed from a data owner to a data user, it is difficult to ensure proper management of handling of the key and usage of the data using the key.

Thus, the present invention has an object to provide a technique which enables secure and sound management of usage of sensitive data between users.

### Solution to the Problem

A data management system of the present invention to overcome the challenge described above is a data management system configured to manage data usage between organizations participating in a distributed ledger system, in which in a node of a first organization, data is encrypted and passed to a node of a second organization, and in an encrypted region in the node of the second organization, the encrypted data is decrypted, and predetermined processing is executed on the decrypted data.

Also, a data management method of the present invention is a data management method performed in a data management system configured to manage data usage between organizations participating in a distributed ledger system, the data management method including: by a node of a first organization, encrypting data and passing the encrypted data to a node of a second organization; and by the node of the second organization, in its own encrypted region, decrypting the encrypted data and executing predetermined processing on the decrypted data.

### Advantageous Effects of the Invention

The present invention enables secure and sound management of usage of sensitive data between users.

### BRIEF DESCRIPTION OF DRAWINGS

FIG. 1 is a diagram showing an example network configuration of a confidential data storage, management, and sharing system using a distributed ledger in the present embodiment of the present embodiment.

FIG. 2 is a diagram showing the hardware configuration of a distributed ledger node (on-chain region) 0010 in the present embodiment.

FIG. 3 is a diagram showing the hardware configuration of an off-chain region 0011 in the present embodiment.

FIG. 4 is a diagram showing information on metadata managed by a metadata management smart contract 0252 in the present embodiment.

FIG. 5 is a diagram showing key information managed by a key management smart contract in the present embodiment

FIG. 6 is a diagram showing trail information managed by a trail management smart contract in the present embodiment

FIG. 7 is a diagram showing encrypted data saved in an encrypted data storage part in the present embodiment.

FIG. 8 is a diagram showing a flowchart of data saving in the present embodiment.

FIG. 9 is a diagram showing a flowchart of data sharing in the present embodiment.

FIG. 10 is a diagram showing a flowchart of decryption and usage of encrypted data in the present embodiment.

### DESCRIPTION OF EMBODIMENTS

### Network Configuration

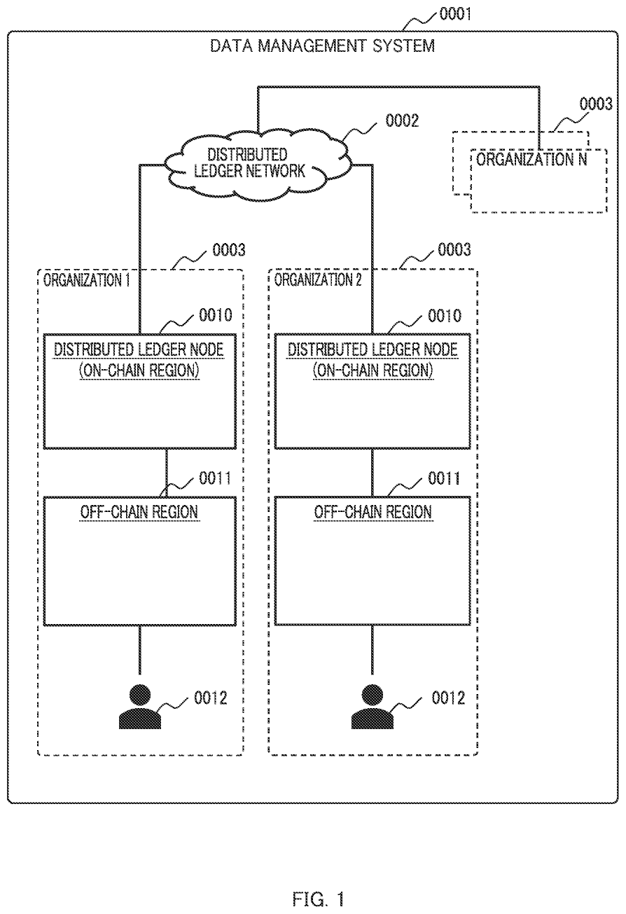

The following describes an embodiment of the present invention in detail using the drawings. FIG. 1 is a diagram showing an example configuration of a data management system 0001 of the present embodiment. The data management system 0001 shown in FIG. 1 is a distributed ledger system that enables secure and sound management of usage of sensitive data between users.

As shown in FIG. 1, the data management system 0001 of the present embodiment is such that distributed ledger nodes 0010 and off-chain regions 0011 of respective organizations 0003 are communicatively coupled and configured via a distributed ledger network 0002. In a mode assumed herein, the off-chain region 0011 is, like the distributed ledger node 0010, implemented in a predetermined information processing apparatus.

As exemplified, each organization 0003, which is an organization participating in the distributed ledger system, operates one or more distributed ledger nodes 0010 and one or more off-chain regions 0011. Also, each organization 0003 includes one or more users 0012.

### Hardware Configuration

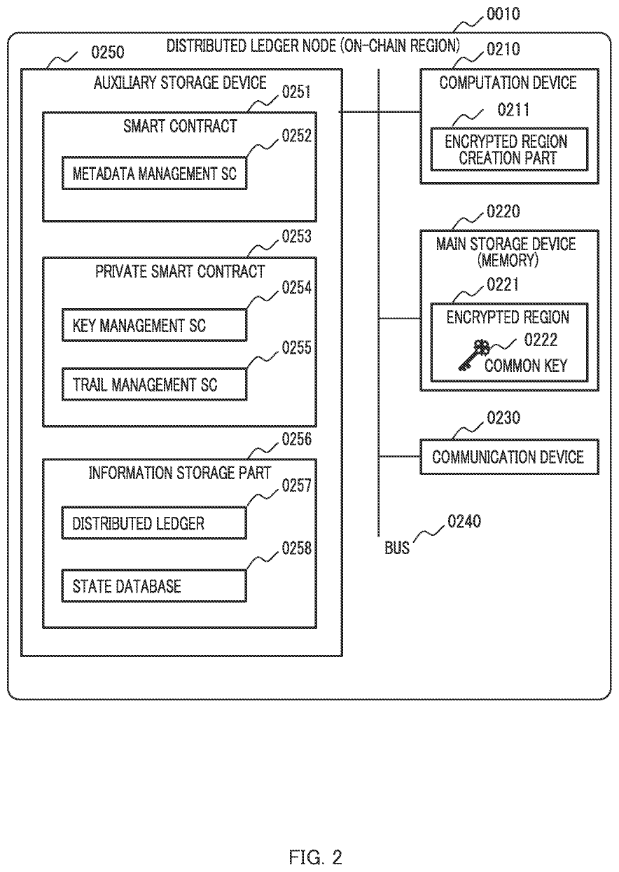

The following shows the hardware configuration of each apparatus forming the data management system 0001 in the present embodiment of the present embodiment. FIG. 2 is a diagram showing the distributed ledger node (on-chain region) 0010 in the present embodiment.

The distributed ledger node 0010 is formed by a computation device 0210, a main storage device (memory) 0220, a communication device 0230, and an auxiliary storage device 0250, and they are coupled via a BUS 0240.

The computation device 0210 is a CPU (Central Processing Unit) that executes a program held in the auxiliary storage device 0250 by, e.g., loading it into the main storage device (memory) 0220 to perform overall control of the apparatus itself and to perform processing for various kinds of determination, computation, and control.

Also, the computation device 0210 has an encrypted region creation part 0211 called TEE (Trusted Execution Environment) that encrypts part of the region of the main storage device (memory) 0220.

Also, all the encrypted region creation parts 0211 and encrypted regions 0221 in the present embodiment have a common encryption key (a common key 0222).

The memory 0220, which is the main storage device, is formed by a volatile storage device such as a RAM (Random Access Memory).

This memory 0220 has the encrypted region 0221 created therein by having part of its region encrypted by the encrypted region creation part 0211 of the computation device 0210 in order to make it impossible for an outsider to view information in the memory and to prevent, e.g., attacks by attackers.

The auxiliary storage device 0250 is formed by an appropriate nonvolatile storage device such as an SSD (Solid State Drive) or a hard disk drive.

Note that in the above-described auxiliary storage device 0250, a smart contract 0251, a private smart contract 0253, and an information storage part 0256 are stored.

The smart contract 0251 is a smart contract that has a metadata management SC 0252 and manages metadata. Note that “SC” stands for smart contract.

The private smart contract 0253 has a key management SC 0254 and a trail management SC 0255, and these private smart contracts are executed on the encrypted region 0221 created by the encrypted region creation part 0211 in a confidential manner.

The information storage part 0256 has a distributed ledger 0257 and a state database 0258.

Of these, the distributed ledger 0257 is data formed by connecting blocks of data of transactions like a chain, and is a blockchain.

Meanwhile, the state database 0258 is a database for saving the latest table data obtained by execution of a transaction managed by the distributed ledger 0257.

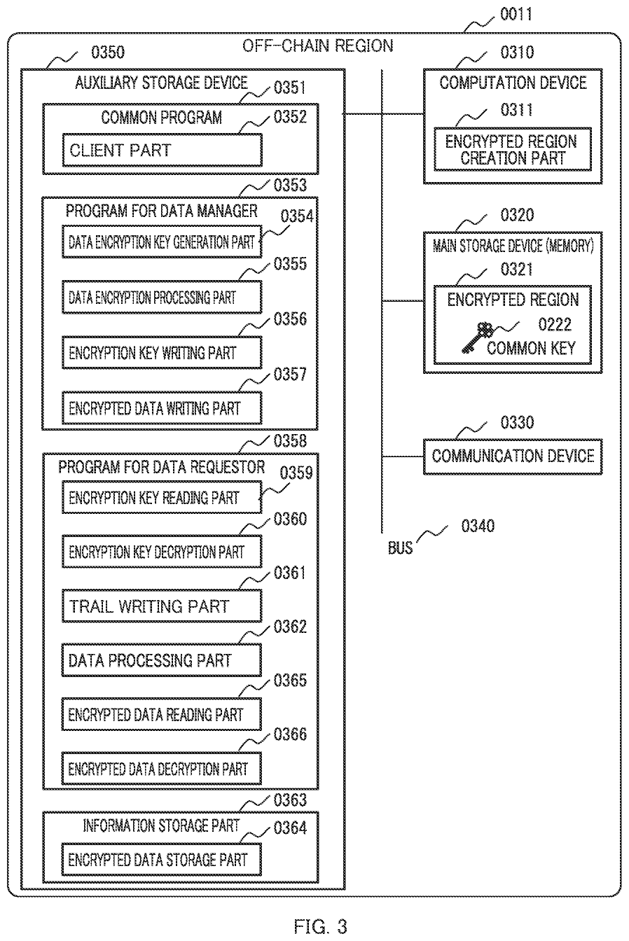

FIG. 3 is a region outside the distributed ledger node in the present embodiment and is the off-chain region 0011. The distributed ledger node 0010 and the off-chain region 0011 may exist in the same machine or different machines.

The off-chain region 0011 is formed by a computation device 0310, a main storage device (memory) 0320, a communication device 0330, and an auxiliary storage device 0350, and they are coupled via a BUS 0340.

Of these, the computation device 0310 is a CPU (Central Processing Part) that executes a program held in the auxiliary storage device 0350 by, e.g., loading it to the main storage device 0320 to perform overall control of the apparatus itself and to perform processing for various kinds of determination, computation, and control.

Also, the computation device 0310 has an encrypted region creation part 0311 called TEE (Trusted Execution Environment) that encrypts part of the region of the main storage device 0320.

Also, all the encrypted region creation parts 0311 and encrypted regions 0321 in the present embodiment have a common encryption key (the common key 0222).

The memory 0320, which is a main storage part, is formed by a volatile storage device such as a RAM (Random Access Memory).

This memory 0320 has the encrypted region 0321 created therein by having part of its region encrypted by the encrypted region creation part 0311 of the computation device 0310 in order to make it impossible for an outsider to view information in the memory and to prevent, e.g., attacks by attackers.

The auxiliary storage device 0350 is formed by an appropriate nonvolatile storage device such as an SSD (Solid State Drive) or a hard disk drive.

In the auxiliary storage device 0350, a common program 0351, a program 0353 for the data manager, a program 0358 for the data requestor, and an information storage part 0363 are stored.

Of these, the common program 0351 has a client part 0352 which is a client program operated by a user and has an user interface.

The program 0353 for the data manager is a program for encrypting and storing data and has a data encryption key generation part 0354, a data encryption processing part 0355, an encryption key writing part 0356, and an encrypted data writing part 0357.

The program 0358 for the data requestor is a program for receiving encrypted data, decrypting the data, and processing the data, and has an encryption key reading part 0359, an encryption key decryption part 0360, a trail writing part 0361, a data processing part 0362, an encrypted data reading part 0365, and an encrypted data decryption part 0366.

Also, the information storage part 0363 is a storage for storing encrypted data and has an encrypted data storage part 0364.

### Example Data Structures

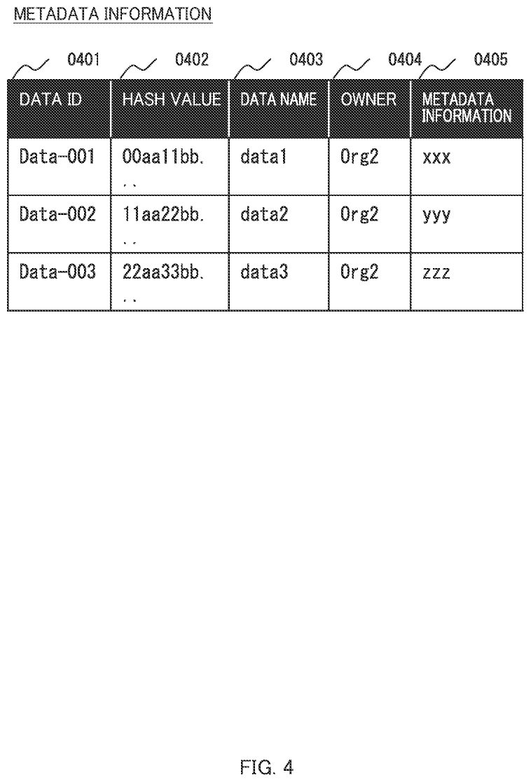

Next, various kinds of information that the data management system 0001 of the present embodiment uses are described. FIG. 4 shows metadata information in the present embodiment, which is data managed by the state database 0258 in the distributed ledger node 0010.

The state database 0258 is a database in which to save the latest results obtained by execution of a transaction managed by the distributed ledger 0257.

As metadata information, with a data ID 0401 as a key, a hash value 0402, a data name 0403, an owner 0404, and other metadata information 0405 are managed.

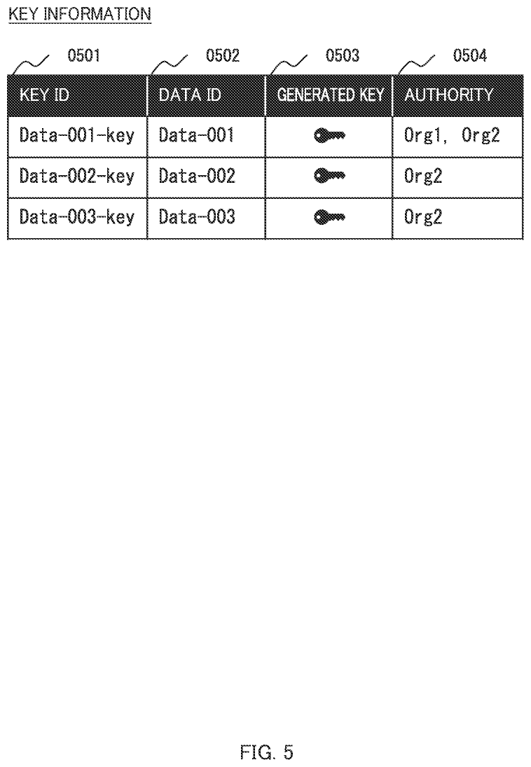

FIG. 5 is key information in the present embodiment and is information managed by the state database 0258 in the distributed ledger node 0010.

As this key information, with a key ID 0501 as a key, pieces of information linked thereto are managed, which are a data ID 0502, an encryption key main body 0503, and an authority 0504 indicating information on an organization permitted to use the key.

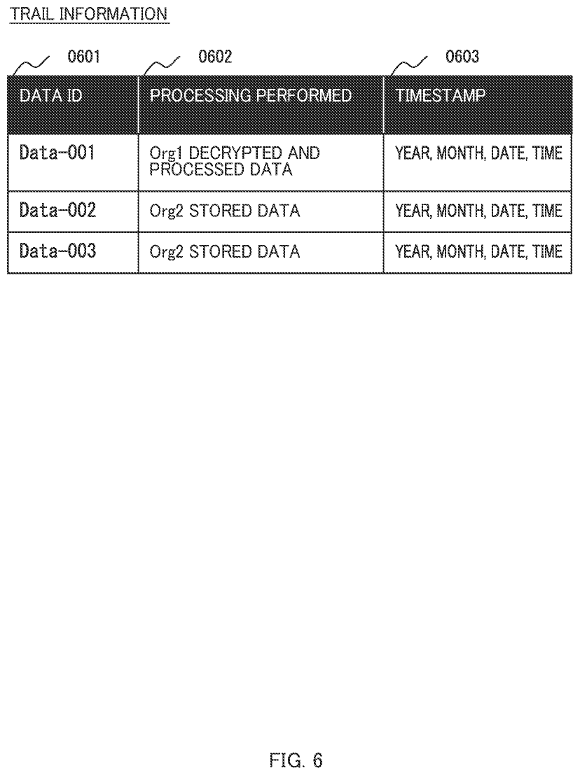

FIG. 6 is trail information in the present embodiment and is information managed by the state database 0258 in the distributed ledger node 0010.

As this trail information, with a data ID 0601 as a key, processing performed 0602 which should be left as a trail, its timestamp 0603, and the like are managed.

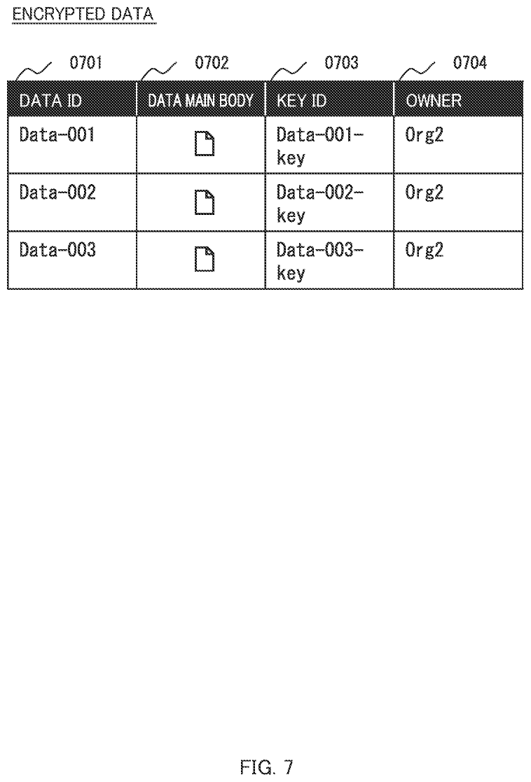

FIG. 7 is encrypted data in the present embodiment and is data managed in the encrypted data storage part 0364 in the off-chain region.

As this encrypted data, with a data ID 0701 as a key, a data main body 0702 encrypted with an encryption key, a key ID 0703 of the key used to encrypt the data, and information 0704 on an organization or user that owns the data are managed.

### Flowchart Example 1: Saving Data

Actual procedures of the data management method of the present embodiment are described below based on the drawings. Various operations corresponding to the data management method described below are implemented by programs that the apparatuses forming the data management system 0001 load into their memories or the like and execute. The programs are formed by code for performing various operations described below.

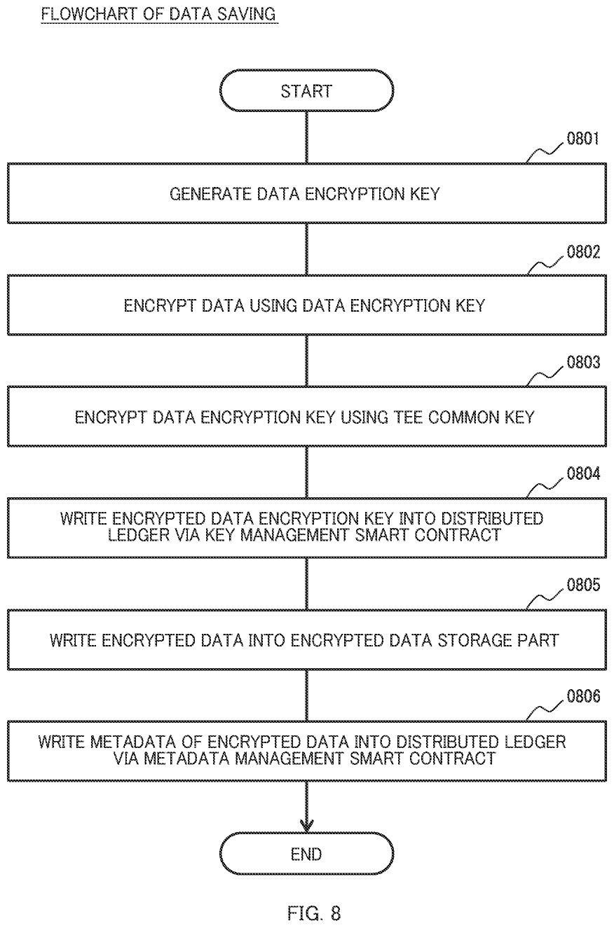

FIG. 8 is a diagram showing an example flowchart of the data management method of the present embodiment. This flowchart shows how one organization (organization B in this example) stores data in the present embodiment.

First, in the off-chain region 0011 of the organization B, the data encryption key generation part 0354 of the program 0353 for the data manager generates a key for encrypting the data (0801).

Next, the data encryption processing part 0355 encrypts the data using the data encryption key generated in Step 0801 above (0802).

Next, the data encryption processing part 0355 encrypts the data encryption key generated in Step 0801 above using the encrypted region common key 0222, (0803).

Next, the data encryption processing part 0355 writes the data encryption key encrypted in Step 0803 above using the encrypted region common key 0222 into the distributed ledger 0257 via the key management smart contract 0254 of the private smart contract 0253 in the distributed ledger node 0010 (0804).

Next, the data encryption processing part 0355 writes the data encrypted in Step 0802 above into the encrypted data storage part 0364 of the information storage part 0363 in the off-chain region 0011 (0805).

Lastly, the data encryption processing part 0355 writes information (metadata) related to the encrypted data into the distributed ledger 0257 via the metadata management smart contract 0252 of the distributed ledger node 0010 (0806).

### Flowchart Example 2: Sharing Encrypted Data

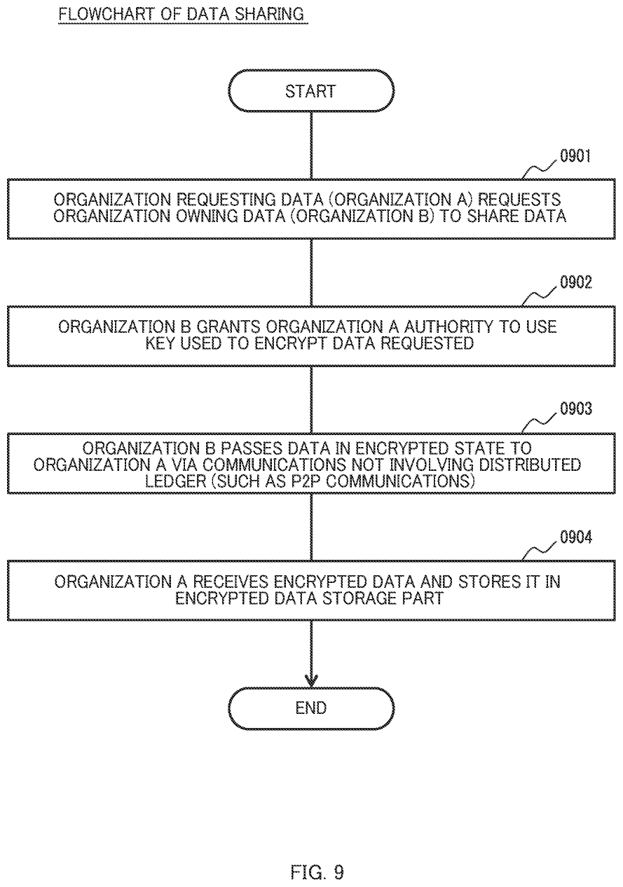

FIG. 9 is a diagram showing a flowchart of sharing encrypted data in the present embodiment. Here, as the premise of the processing, an organization that requests data is an “organization A,” and an organization that owns the data with the “organization A” in response to the request is an “organization “B.”

In this case, first, a given apparatus in the organization A described above notifies a given apparatus in the organization B of a data sharing request (0901). Those apparatuses in the respective organizations may be, but are not limited to, client nodes (not shown) coupled to the distributed ledger node 0010 and the distributed ledger node 0010.

The distributed ledger node 0010 of the organization B, upon receipt of the request from the above organization A, grants the organization A the authority 0504 to use the key used to encrypt the data that is the object of the request for sharing (0902). Specifically, identification information on the organization B is written into the authority 0504 in the key information shown in FIG. 5.

Also, the off-chain region 0011 of the organization B passes the data in an encrypted state directly to the off-chain region 0011 of the organization A using communication that does not involve a distributed ledger (such as, e.g., peer-2-peer communications) (0903).

Lastly, the off-chain region 0011 of the organization A receives the encrypted data and stores this in its own encrypted data storage part 0364.

### Flowchart Example 3: Decrypting and Using Encrypted Data

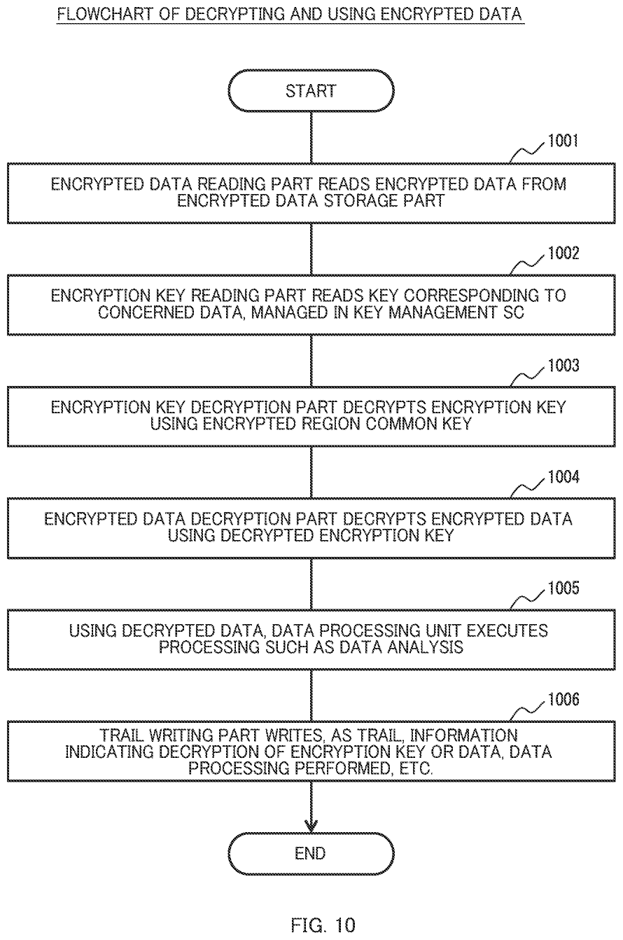

FIG. 10 is a diagram showing a flowchart of decrypting and using encrypted data in the present embodiment.

First, the encrypted data reading part 0365 in the program 0358 for the data requestor in the off-chain region 0011 reads encrypted data (received from organization B) from the encrypted data storage part 0364 (1001).

Next, the encryption key reading part 0359 obtains a key for decrypting the encrypted data the authority for which has been granted in Step 0902, via the private smart contract 0254 of the private smart contract 0253 in the distributed ledger node 0010 (1002).

Next, the encryption key decryption part 0360 decrypts the encryption key obtained in Step 1002 using the encrypted region common key 0222 (1003).

Next, the encrypted data decryption part 0366 decrypts the encrypted data received from organization B using the encryption key decrypted in Step 1003 (1004).

Next, the data processing part 0362 executes processing for usage of the decrypted data, such as predetermined data analysis, using the decrypted data obtained in Step 1004 (1005).

Lastly, the trail writing part 0361 writes information indicating that the data encryption key and the data have been decrypted, data processing performed, and the like into the state database 0258 as the trail information (see FIG. 6) (1006).

Although the best mode for carrying out the present invention and the like have been described above in concrete terms, the present invention is not limited to the above and can be variously modified without departing from the gist thereof.

As such, the present embodiment enables secure and sound management of usage of sensitive data between users.

The description herein clarifies at least the following points. Specifically, the data management apparatus of the present embodiment may be such that in the node of the first organization, the data is encrypted on an encrypted region created using an encrypted region creation function built into a computation apparatus.

This enables the data encryption itself to be achieved in a secure manner. By extension, this enables more secure and sound management of usage of sensitive data between users.

Also, the data management apparatus of the present embodiment may be such that in the nodes of the first and second organizations, the encrypted data is managed in a distributed ledger as metadata.

Then, in reference and extraction of the encrypted data, data search in the blockchain is avoided, and the encrypted data can be easily managed in the state database. By extension, this enables more secure and sound management of usage of sensitive data between users.

Also, the data management apparatus of the present embodiment may be such that in the nodes of the first and second organizations, the metadata on the distributed ledger is made confidential by a smart contract operated using a private smart contract function.

This enables management of the metadata to be secure. By extension, this enables more secure and sound management of usage of sensitive data between users.

Also, the data management apparatus of the present embodiment may be such that in the node of the first organization, on the encrypted region in an off-chain region, an encryption key for encrypting the data is generated, and the data is encrypted using the key.

This enables the encryption key generation itself to be secure. By extension, this enables more secure and sound management of usage of sensitive data between users.

Also, the data management apparatus of the present embodiment may be such that in the node of the first organization, the generated key is encrypted using a common key in the encrypted region, and the encryption key is managed and shared via a key management smart contract in a distributed ledger node in the distributed ledger system.

This enables the key generation and management to be more secure, and by extension, enables more secure and sound management of usage of sensitive data between users

Also, the data management apparatus of the present embodiment may be such that in the node of the first organization, in the key management smart contract, the first organization which is an owner of a key managed by the key management smart contract grants the second organization predetermined authority and enables the second organization to use the key.

This enables key management while properly addressing key leakage. By extension, this enables more secure and sound management of usage of sensitive data between users.

Also, the data management apparatus of the present embodiment may be such that in the node of the second organization, upon receipt of the encrypted data from the node of the first organization, the data is decrypted using the key in its own encrypted region, and predetermined processing is executed on the decrypted data.

This enables decryption and usage of encrypted data to be implemented in a secure manner. By extension, this enables more secure and sound management of usage of sensitive data between users.

Also, the data management apparatus of the present embodiment may be such that in the node of the second organization, when the data is decrypted and subjected to the predetermined processing, trail is written into the distributed ledger using a trail management smart contract.

This enables secure management of trail of each processing, and by extension, enables more secure and sound management of usage of sensitive data between users.

Also, the data management method of the present embodiment may be such that in the node of the first organization, the data is encrypted on an encrypted region created using the encrypted region creation function built in a computation apparatus.

Also, the data management method of the present embodiment may be such that in the nodes of the first and second organizations, the encrypted data is managed in a distributed ledger as metadata.

Also, the data management method of the present embodiment may be such that in the nodes of the first and second organizations, the metadata on the distributed ledger is made confidential by a smart contract operated using a private smart contract function.

Also, the data management method of the present embodiment may be such that in the node of the first organization, on the encrypted region in an off-chain region, an encryption key for encrypting the data is generated, and the data is encrypted using the key.

Also, the data management method of the present embodiment may be such that in the node of the first organization, the generated key is encrypted using a common key in the encrypted region, and the encryption key is managed and shared via a key management smart contract in a distributed ledger node in the distributed ledger system.

Also, the data management method of the present embodiment may be such that in the node of the first organization, in the key management smart contract, the first organization which is an owner of a key managed by the key management smart contract grants the second organization predetermined authority and enables the second organization to use the key.

Also, the data management method of the present embodiment may be such that in the node of the second organization, upon receipt of the encrypted data from the node of the first organization, the data is decrypted using the key in its own encrypted region, and predetermined processing is executed on the decrypted data.

Also, the data management method of the present embodiment may be such that in the node of the second organization, when the data is decrypted and subjected to the predetermined processing, trail is written into the distributed ledger using a trail management smart contract.

### REFERENCE SIGNS LIST

0001 data management system
0002 distributed ledger network
0003 organization
0010 distributed ledger node
0011 off-chain region
0210, 0310 computation device
0211, 0311 encrypted region creation part
0220, 0320 main storage device
0221, 0321 encrypted region
0222 common key
0230, 0330 communication device
0240, 0340 BUS
0250, 0350 auxiliary storage device
0251 smart contract
0252 metadata management SC
0253 private smart contract
0254 key management SC
0255 trail management SC
0256 information storage part
0257 distributed ledger
0258 state database
0351 common program
0352 client part
0353 program for the data manager
0354 data encryption key generation part
0355 data encryption processing part
0356 encryption key writing part
0357 encrypted data writing part
0358 program for the data requestor
0359 encryption key reading part
0360 encryption key decryption part
0361 trail writing part
0362 data processing part
0363 information storage part
0364 encrypted data storage part
0365 encrypted data reading part
0366 encrypted data decryption part

1. A data management system configured to manage data usage between organizations participating in a distributed ledger system, wherein
in a node of a first organization, data is encrypted and passed to a node of a second organization, and
in an encrypted region of the node of the second organization, the encrypted data is decrypted, and predetermined processing is executed on the decrypted data.

2. The data management system according to claim 1, wherein
in the node of the first organization, the data is encrypted on an encrypted region created using an encrypted region creation function built into a computation apparatus.

3. The data management system according to claim 2, wherein
in the nodes of the first and second organizations, the encrypted data is managed in a distributed ledger as metadata.

4. The data management system according to claim 3, wherein
in the nodes of the first and second organizations, the metadata on the distributed ledger is made confidential by a smart contract operating using a private smart contract function.

5. The data management system according to claim 4, wherein
in the node of the first organization, on the encrypted region in an off-chain region, an encryption key for encrypting the data is generated, and the data is encrypted using the key.

6. The data management system according to claim 5, wherein
in the node of the first organization, the generated key is encrypted using a common key in the encrypted region, and
the encryption key is managed and shared via a key management smart contract in a distributed ledger node in the distributed ledger system.

7. The data management system according to claim 6, wherein
in the node of the first organization, in the key management smart contract, the first organization, which is an owner of a key managed by the key management smart contract, grants the second organization predetermined authority and enables the second organization to use the key.

8. The data management system according to claim 7, wherein
in the node of the second organization, upon receipt of the encrypted data from the node of the first organization, the data is decrypted using the key in its own encrypted region, and predetermined processing is executed on the decrypted data.

9. The data management system according to claim 8, wherein
in the node of the second organization, when the data is decrypted and subjected to the predetermined processing, a trail is written into the distributed ledger using a trail management smart contract.

10. A data management method performed in a data management system configured to manage data usage between organizations participating in a distributed ledger system, the data management method comprising:
by a node of a first organization, encrypting data and passing the encrypted data to a node of a second organization; and
by the node of the second organization, in its own encrypted region, decrypting the encrypted data and executing predetermined processing on the decrypted data.

11. The data management method according to claim 10, wherein
in the node of the first organization, the data is encrypted on an encrypted region created using an encrypted region creation function built in a computation apparatus.

12. The data management method according to claim 11, wherein
in the nodes of the first and second organizations, the encrypted data is managed in a distributed ledger as metadata.

13. The data management method according to claim 12, wherein
in the nodes of the first and second organizations, the metadata on the distributed ledger is made confidential by a smart contract operated using a private smart contract function.

14. The data management method according to claim 13, wherein
in the node of the first organization,
on the encrypted region in an off-chain region, an encryption key for encrypting the data is generated, and the data is encrypted using the key.

15. The data management method according to claim 14, wherein
in the node of the first organization, the generated key is encrypted using a common key in the encrypted region, and
the encryption key is managed and shared via a key management smart contract in a distributed ledger node in the distributed ledger system.

16. The data management method according to claim 15, wherein
in the node of the first organization, in the key management smart contract, the first organization, which is an owner of a key managed by the key management smart contract, grants the second organization predetermined authority and enables the second organization to use the key.

17. The data management method according to claim 16, wherein
in the node of the second organization, upon receipt of the encrypted data from the node of the first organization, the data is decrypted using the key in its own encrypted region, and predetermined processing is executed on the decrypted data.

18. The data management method according to claim 17, wherein
in the node of the second organization, when the data is decrypted and subjected to the predetermined processing, a trail is written into the distributed ledger using a trail management smart contract.
